(19) United States
(12) Patent Application Publication
(10) Pub. No.: US 2015/0179228 A1
(43) Pub. Date: Jun. 25, 2015

(54) SYNCHRONIZED MOVIE SUMMARY

(71) Applicant: THOMSON LICENSING, Issy de Moulineaux (FR)

(72) Inventors: Lionel Oisel, La Nouaye (FR); Joaquin Zepeda, St.-Jacques-De-La-Lande (FR); Louis Chevallier, La Meziere (FR); Patrick Perez, Rennes (FR); Pierre Hellier, Thorigne Fouillard (FR)

(73) Assignee: THOMSON LICENSING, ISsy de Moulineaux (FR)

(21) Appl. No.: 14/411,347

(22) PCT Filed: Jun. 18, 2013
(86) PCT No.: PCT/EP2013/062568

§ 371 Date: Dec. 24, 2014

(30) Foreign Application Priority Data
Jun. 25, 2012 (EP) 12305733.3

(51) Int. Cl. G11B 27/30; H04N 21/234; H04N 21/8549; G11B 27/10

(52) U.S. Cl. CPC G11B 27/3081; G11B 27/102; H04N 21/23418; H04N 21/8549

(57) ABSTRACT

The present invention relates to a method for providing a summary of an audiovisual object. The method comprises the steps of: capturing information from the audiovisual object; identifying the audiovisual object; determining the time index of the captured information relative to the audiovisual object; and providing a summary of a portion of the identified audiovisual object, the portion being comprised between the beginning and the determined time index of the identified audiovisual object.

### TECHNICAL FIELD

The present invention relates to a method for providing a summary of an audiovisual object.

### BACKGROUND

It may occur that a viewer misses the beginning of an audiovisual object being played back. Facing with that problem, the viewer would like to know what is missed. The U.S. patent application Ser. No. 11/568,122 addresses this problem by providing an automatic summarization of a portion of a content stream for a program using a summarization function mapping the program to a new segment space and depending upon whether the content portion is a beginning, intermediate, or ending portion of the content stream.

It is one object of the present invention to provide an end user a summary which is better tailored to the content the end user actually missed.

### SUMMARY OF THE INVENTION

To this end, the present invention proposes a method for providing a summary of an audiovisual object, comprising the steps of:
(i) capturing information from the audiovisual object that allows to identify the audiovisual object and allows to determine a time index relative to the audiovisual object;
(ii) identifying the audiovisual object;
(iii) determining the time index of the captured information relative to the audiovisual object; and
(iv) providing a summary of a portion of the identified audiovisual object, the portion being comprised between the beginning and the determined time index of the identified audiovisual object.

The determination of the time index enables to precisely evaluate the portion of the audiovisual object which has been missed by a user, and to generate and to provide a summary tailored to the missed portion. As a result, the user is provided with a summary containing information relevant to what the user missed and bounded by the determined time index. For example, spoilers of an audiovisual object are not disclosed in the provided summary.

The invention also relates to a method, wherein:
a database comprising data of time-indexed images of the identified audiovisual object is provided;
the captured information is data of an image of the audiovisual object at the capturing time; and
the time index is determined upon a similarity matching between the data of the image of the audiovisual object at the capturing time and the data of the time-indexed images of the identified audiovisual object in the database.

Preferably, the nature of the data of the image of the audiovisual object and the nature of the data of the time-indexed images of the identified audiovisual object are of signature nature.

The advantage of using signatures, in particular, includes that the data become lighter than the raw data, and allow therefore a quicker identifying as well as a quicker matching.

Alternatively, the invention relates to method, wherein:
a database comprising data of time-indexed audio signals of the identified audiovisual object is provided;
the captured information is data of an audio signal of the audiovisual object at the capturing time; and
the time index is determined upon a similarity matching between the data of the audio signal of the audiovisual object at the capturing time and the data of the time-indexed audio signals of the identified audiovisual object in the database.

Preferably, the nature of the data of the audio signal of the audiovisual object and the nature of the data of the time-indexed audio signals of the identified audiovisual object are of signature nature.

Advantageously, the step of capturing is performed by a mobile device.

Advantageously, the step of identifying, the step of determining and the step of providing are performed on a dedicated server.

This way, less processing power is required on the capturing side, and the process of providing a summary is accelerated.

For a better understanding, the invention shall now be explained in more detail in the following description with reference to the figures. It is understood that the invention is not limited to the described embodiments and that specified features can also expediently be combined and/or modified without departing from the scope of the present invention as defined in the appended claims.

### BRIEF DESCRIPTION OF THE DRAWINGS

FIG. 1 shows an exemplary flowchart of a method according to the present invention.

FIG. 2 shows an example of an apparatus allowing the implementation of the method according to the present invention.

### DETAILED DESCRIPTION OF PREFERRED EMBODIMENTS

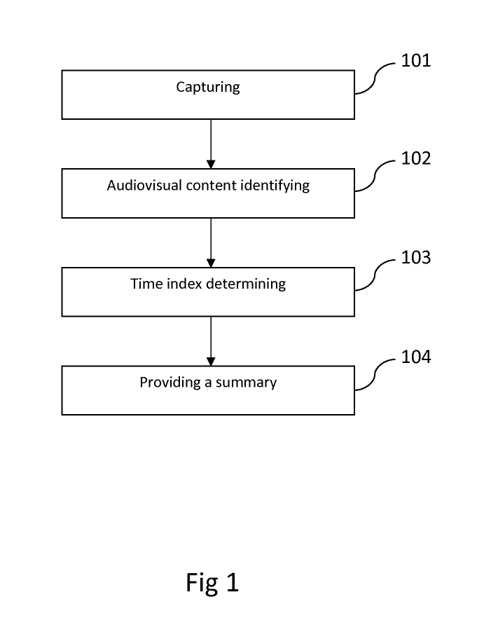

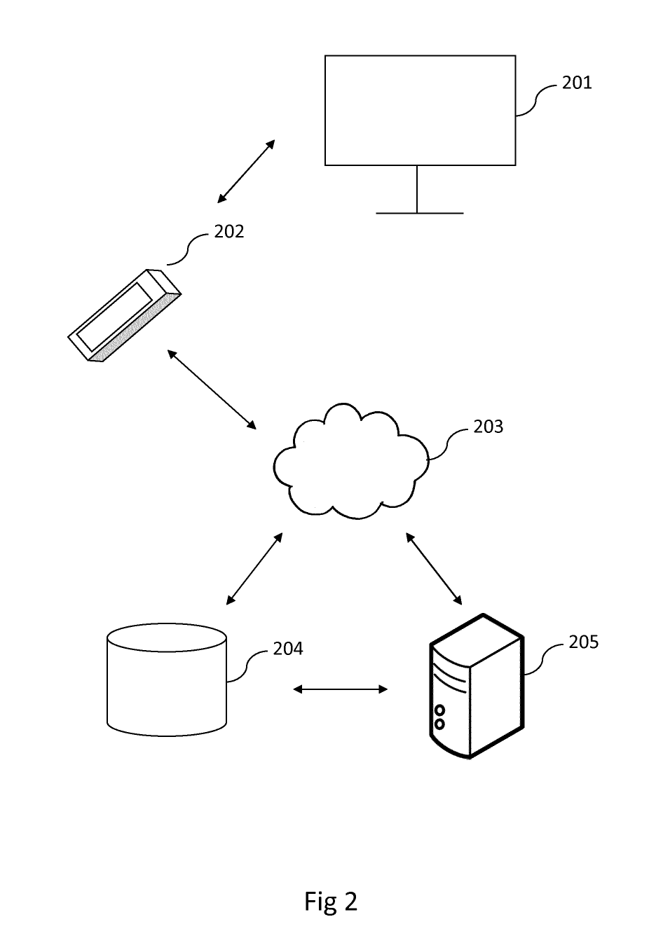

Referring to FIG. 2, an exemplary apparatus configured to implement the method of the present invention is illustrated. The apparatus comprises a rendering device 201, a capturing device 202 and a database 204, and optionally, a dedicated server 205. A first preferred embodiment of the method of the present invention will be explained in more detail with reference to the flow chart in FIG. 1 and the apparatus in FIG. 2.

The rendering device 201 is used for rendering an audiovisual object. For example, the audiovisual object is a movie and the rendering device 201 is a display. Then, information of the rendered audiovisual object, e.g., data of an image of a movie being displayed, is captured 101 by a capturing device 202 equipped with capturing means. Such device 202 is for example a mobile phone equipped with a digital camera. The captured information is used for identifying 102 the audiovisual object and determining 103 a time index relative to the audiovisual object. Subsequently, a summary of a portion of the identified audiovisual object is provided 104, wherein the portion of the object is comprised between the beginning and the determined time index of the identified audiovisual object.

Specifically, the captured information, i.e. the data of an image of the movie, is sent to a database 204, via for example a network 203. The database 204 comprises data of time-indexed images of the identified audiovisual objects, such as a set of movies in this preferred embodiment. Preferably, the data of the image of the audiovisual object and the data of the time-indexed images of the identified audiovisual object in the database are signatures of the images. For example, such a signature may be extracted using a key point descriptor, e.g. SIFT descriptor. Then, the steps of identifying 102 the audiovisual object and determining 103 the time index of the captured information is performed upon a similarity matching between the data of the image of the audiovisual object at capturing time and the data of the time-indexed images in the database 204, i.e. between the signatures of the images. The most similar time-indexed image in the database 204 for the image of the audiovisual object at capturing time is identified, allowing to identify the audiovisual object and to determine the time index of the captured information relative to the audiovisual object. Then a summary of a portion of the identified audiovisual object, which is comprised between the beginning and the determined time index of the identified audiovisual object, is obtained and provided 104 to the user.

The data of the image of the audiovisual object, e.g., the image signature, can be captured either directly by the capturing device 202 equipped with the capturing means or alternatively on a dedicated server 205. Similarly, the steps of identifying 102 the audiovisual object, determining 103 the time index of the captured information, and providing 104 a summary can be alternatively performed on a dedicated server 205.

An advantage of performing the image signature capture directly on the device 202 is that the weight of the data sent to the dedicated server 205 is lighter in terms of memory.

An advantage of performing the signature capture on the dedicated server 205 is that the nature of the signature may be controlled on the server side. Thus the nature of the signature of the image of the audiovisual object and the nature of the signatures of the time-indexed images in the database 204 are the same, and can be directly compared.

The database 204 can be located in the dedicated server 205. It can of course also be located outside the dedicated server 205.

In the above preferred embodiment, the captured information is the data of an image. In a more general manner, the information can be any data that is able to be captured by a capturing device 202 possessing the adapted capturing means, provided the captured data enables identifying 102 of the audiovisual object and determining 103 the time index of the captured information relative to the audiovisual object.

In a second preferred embodiment for the method of this invention, the captured information is data of an audio signal of an audiovisual object at the capturing time. The information can be captured by a mobile device equipped with a microphone or a loudspeaker. The data of the audio signal of the audiovisual object can be a signature of the audio signal, which is then matched to the most similar audio signature among the collection of audio signatures contained in the database 204. The similarity matching is thus used for identifying 102 the audiovisual object and determining 103 the time index of the captured information relative to the audiovisual object. A summary of a portion of the identified audiovisual object is subsequently provided 104, wherein the portion of the object is comprised between the beginning and the determined time index of the identified audiovisual object.

An example for the database 204 and a summary of a portion of the identified audiovisual object will now be described. An offline process is performed in order to generate the database 204, with the help of existing and/or public database. An exemplary database for a collection of a set of movies will be explained now, but the invention is not limited to the description below.

For the summary database of the database 204, a temporally synchronized summary of the full movie is generated. This relies, for example, on an existing synopsis, such as those available on the Internet Movie Database (IMDB). Such synopsis may be retrieved directly from the name of the movie. Synchronization can be performed by synchronizing a textual description of a given movie with an audiovisual object of the given movie, by using for example a transcription of an audio track of the given movie. Then, a matching of the words and concepts extracted from both the transcription and the textual description is performed, resulting in a synchronized synopsis for the movie. The synchronized synopsis may of course be obtained manually.

Optionally, additional information is also extracted. A face detection and a clustering process are applied on the full movie, thus providing clusters of faces which are visible in the movie. Each of the clusters is composed of faces corresponding to the same character. This clustering process may be performed using the techniques detailed in M. Everingham, J. Sivic, and A. Zisserman “Hello! My name is . . . Buffy”—Automatic naming of characters in TV video” Proceedings of the 17th British Machine Vision Conference (BMVC 2006). A list of characters associated with a list of movie time codes associated to the presence of a particular character is then obtained. The obtained clusters may be matched against with an IMDB character list of the given movie for a better clustering result. This matching process may comprise manual steps.

The obtained synchronized synopsis summary and the cluster lists are stored in the database 204. The movies in the database 204 are divided into a plurality of frames, and each of the frames is extracted. The frames of the movie are then indexed for facilitating post-synchronization processes, such as determining 103 a time index of the captured information relative to the movie. Alternatively, instead of extracting each frame of the movie, only a part of the frames are extracted by an adequate sub-sampling, in order to reduce the amount of data to be processed. For each extracted frame, an image signature, e.g., a fingerprint based on key point description, is generated. Those key points and their associated descriptions are indexed in an efficient way, which may be done using the techniques described in H. Jégou, M. Douze, and C. Schmid—Hamming embedding and weak geometric consistency for large scale image search—ECCV, October 2008. The frames of the movies associated with the image signatures are then stored in the database 204.

To obtain the summary of a portion of an identified audiovisual object (i.e. a movie), information of the audiovisual object, e.g., data of an image thereof, is captured by a capturing device 202. The information is then sent to the database 204, and compared to the database 204 for identifying the audiovisual object. For example, a frame of the movie is identified in the database 204 corresponding to the captured information. The identified frame facilitates the matching between the captured information and the synchronized synopsis summary in the database 204, thus determining the time index of the captured information relative to the movie. A synchronized summary of a portion of the movie is then provided to a user, wherein the portion of the movie is comprised between the beginning and the determined time index of the identified movie. For example, the summary can be provided by being displayed on the mobile device 202 and being read by the user. Optionally, the summary can include cluster lists of characters appearing in the portion of the movie.

1-7. (canceled)

8. A method for providing a summary of an audiovisual object, comprising:
(i) capturing information from the audiovisual object that allows to identify the audiovisual object and allows to determine a time index relative to the audiovisual object;
(ii) identifying the audiovisual object;
(iii) determining the time index of the captured information relative to the audiovisual object; and
(iv)providing a summary of a portion of the identified audiovisual object, the portion being comprised between the beginning and the determined time index of the identified audiovisual object.

9. The method of claim 8, wherein:
a database comprising data of time-indexed images of the identified audiovisual object is provided;
the captured information is data of an image of the audiovisual object at the capturing time; and
the time index is determined upon a similarity matching between the data of the image of the audiovisual object at the capturing time and the data of the time-indexed images of the identified audiovisual object in the database.

10. The method of claim 9, wherein:
the nature of the data of the image of the audiovisual object and the nature of the data of the time-indexed images of the identified audiovisual object are of signature nature.

11. The method of claim 8, wherein:
a database comprising data of time-indexed audio signals of the identified audiovisual object is provided;
the captured information is data of an audio signal of the audiovisual object at the capturing time; and
the time index is determined upon a similarity matching between the data of the audio signal of the audiovisual object at the capturing time and the data of the time-indexed audio signals of the identified audiovisual object in the database.

12. The method of claim 11, wherein:
the nature of the data of the audio signal of the audiovisual object and the nature of the data of the time-indexed audio signals of the identified audiovisual object are of signature nature.

13. The method of claim 8, wherein said capturing is performed by a mobile device.

14. The method of claim 8, wherein said identifying, determining and providing are performed on a dedicated server.

15. The method of claim 9, wherein said capturing is performed by a mobile device.

16. The method of claim 11, wherein said identifying, determining and providing are performed on a dedicated server.
